(19) United States
(12) Patent Application Publication
(10) Pub. No.: US 2012/0085268 A1
(43) Pub. Date: Apr. 12, 2012

(54) PORTABLE WORKSTATION

(76) Inventor: Steve Straface, Elmsford, NY (US)

(21) Appl. No.: 12/900,850

(22) Filed: Oct. 8, 2010

(51) Int. Cl. B25H 1/04; B25H 1/16; B25H 1/12

(52) U.S. Cl. 108/25

(57) ABSTRACT

A portable work station having legs, a central storage compartment, and a work platform. The legs are telescopically adjustable, permitting the overall length of the legs to be changed. Each leg is pivotally connected to a respective side of the central storage compartment so that each leg is movable with respect to the central storage compartment into an open position forming an A-frame with the central storage compartment at the apex of the A-frame. A work platform is pivotally connected to one of the legs and movable entirely on one side of the A-frame from a folded position to a working position so that the work platform is disposed on one side of the central storage compartment. A storage device can be attached to the other leg, and can act as a counterbalance to the work platform to enhance the stability of the workstation.

### FIELD OF THE INVENTION

The present invention generally relates to the field of workstations and tool carriers, and more particularly to a portable workstation that provides storage for tools and supplies and an adjustable height work surface.

### BACKGROUND OF THE INVENTION

Maintenance and repair personnel, electricians, plumbers, HVAC specialists, carpenters, and other trade professionals often have to make on site visits to service equipment, make repairs, or perform installations. Accordingly, such professionals are required to bring tools, parts, and supplies, etc, with them to each job site. The need to be mobile presents a challenge to carry efficiently and effectively the required equipment and supplies to multiple locations as necessitated. An additional problem arises when the professional arrives at the job location and needs a work surface to assemble parts or perform necessary cuts, drilling, bending or other operations. Often times the professional will resort to working on the floor or using a client's property to create a makeshift worktable. This leaves the professional working in uncomfortable positions and/or faced with the risk of damaging the client's property.

What is needed in the art is an improved, novel workstation that provides a work platform, storage for items with easy access thereto, and is adjustable in height and is collapsible to a reduced size for portability and storage. The present invention addresses these and other needs.

### SUMMARY OF THE INVENTION

TO BE DRAFTED ONCE CLAIMS ARE FINALIZED

In accordance with one aspect of the invention, a portable work station comprises first and second legs, each leg having an upper portion and a ground contacting portion telescopically coupled with the upper portion. A central storage compartment is suspended by the legs above the ground, the upper portion of each leg being pivotally connected to a respective side of the central storage compartment so that each leg is movable with respect to the central storage compartment into an open position forming an A-frame with the central storage compartment at the apex of the A-frame. A work platform is pivotally connected to one of the legs and movable entirely on one side of the A-frame from a folded position, wherein a second end of the work platform is proximate the leg to which it is connected, to a working position, wherein the second end is remote from the leg to which it is connected and the first end is adjacent the central storage compartment so that the work platform is disposed on one side of the central storage compartment.

In accordance with a further aspect of the invention, a storage device is connected to the other leg and is disposed on the side of the central storage compartment opposite the work platform to provide a counterweight to the work platform.

In further aspects, the storage device comprises a piece of fabric material and at least one pocket.

In accordance with another aspect of the invention, the storage device comprises a bin having at least one compartment.

In accordance with an aspect of the invention, the upper and ground contacting portions of each respective leg are telescopically adjustable to adjust an overall length of each leg.

In accordance with a further aspect of the invention, the first and second legs are movable with respect to the central storage compartment to a closed position such that the first and second legs are generally parallel to each other.

In further aspects, the work station includes a support member having a first end pivotally connected to the second end of the work platform, wherein the support member is pivotally adjustable between a folded position wherein a second end of the support member is proximate the work platform, to a supporting position wherein a second end of the support member is remote from the work platform and is detachably coupled to the leg to which the work platform connected.

In accordance with another aspect, the support member has a width that is smaller than a width of the leg to which the work platform is connected so that the support member is capable of nesting with the leg to which the work platform is connected when the support member is in the folded position and the work platform is in the collapsed position.

In further aspects, a handle is attached to the central storage compartment.

These and other aspects, features and advantages of the invention can be understood with reference to the following description of certain embodiments of the invention in conjunction with the accompanying Drawings.

### BRIEF DESCRIPTION OF THE DRAWINGS

FIG. 1 is a perspective side view showing a portable workstation in use;

FIG. 2 is a perspective view showing the portable workstation with legs in a retracted position;

FIG. 3 is a perspective view showing the portable workstation with the legs extended; and

FIG. 4 is a side view of the portable workstation with legs retracted and the work platform folded.

### DETAILED DESCRIPTION OF CERTAIN EMBODIMENTS OF THE INVENTION

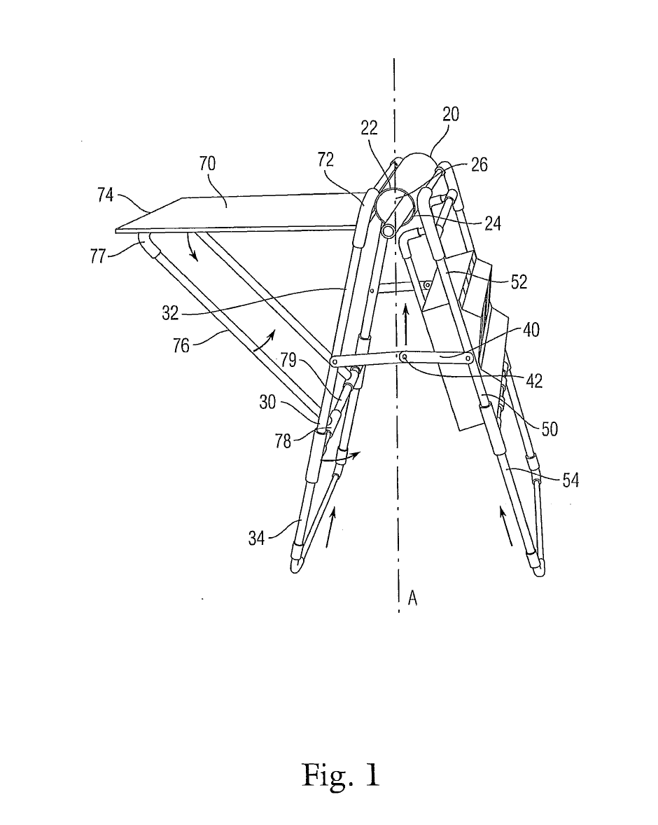

FIG. 1 illustrates a side view a portable workstation 10 according to one embodiment of the present invention. The portable workstation 10 includes a central storage compartment 20 and first and second legs 30 and 50 pivotally connected to the central storage compartment 20. A work platform 70 is pivotally connected to leg 30 and a storage device 90 is supported by leg 50.

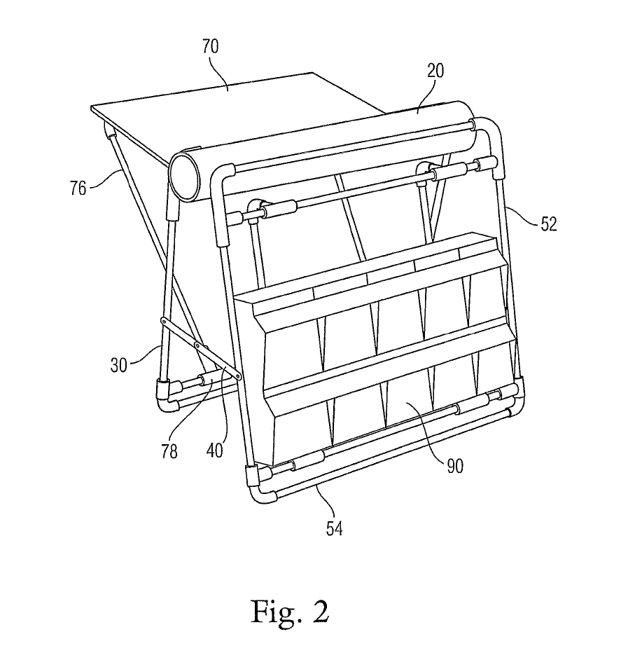

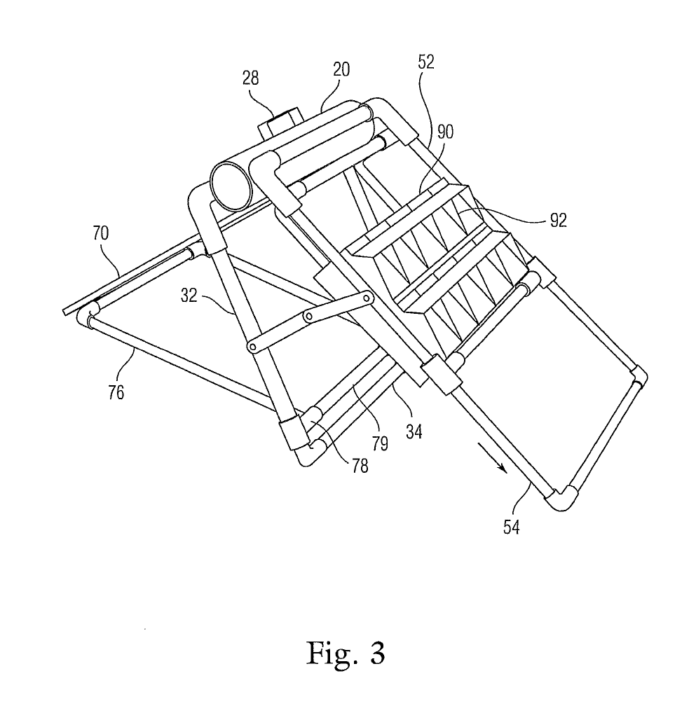

The first and second legs 30 and 50 support the central storage compartment 20 above the ground surface. First and second legs 30 and 50 each have an upper portion 32 and 52 and a ground contacting portion 34 and 54, respectively. The upper portion 32, 52 of each leg is telescopically coupled with the ground contacting portion 34, 54 for adjustment of the length of the legs 30, 50. The telescopic adjustment of the legs allows a user to adjust the height of the work platform 70 and the storage compartment 20. The ground contacting portions 34, 54 can be retracted into the upper portions 32, 52 of the legs to lower the work platform 70. FIG. 2 shows the legs in a retracted position with the work platform 70 and storage compartment 20 at a lower height above the ground surface. In order to raise the work platform 70 and storage compartment 20, the ground contacting portions 32, 52 are telescopically extended from the upper portions 32, 52. The telescopic extension of ground contacting portion 54 from upper portion 52 of leg 50 can be seen in FIG. 3, which shows one of the legs in a retracted position and the other in an extended position.

Each respective upper portion 32, 52 and ground contacting portion 34, 54 is locked into position once it has been telescopically adjusted to provide the desired height. Each portion of the legs can be provided with corresponding holes in the walls of the tube so that a locking pin can be inserted through a hole in the upper portions 32, 52 into a hole in the ground contacting portions 34, 54 to fix the leg portions relative to each other to prevent further telescopic sliding.

Other suitable locking mechanisms such as a push detent button or a compression fitting, can be used to lock the telescoping portions of legs.

The telescopic adjustment of the legs 30, 50 allows the workstation 10 to accommodate users of differing heights. Instead of the user having to work on the ground or on a client's table, the workstation 10 includes work platform 70 to provide the user with a surface to place items and perform other necessary operations. The storage compartment 20 provides an easily accessible storage space for a user to store tools, supplies, etc. in close proximity to the work platform 70. As discussed in more detail below, the work platform 70 is positioned completely to one side of the workstation 10 so as not to cover or block access to storage compartment 20. The arrangement of the legs, storage compartment, and work platform permits simultaneous adjustment of the height of the work platform 70 and storage compartment 20 by adjusting the length of the legs. The adjustment of the legs causes the work platform 70 and storage compartment 20 to move together as a unit. This provides advantages to the user because the work platform 70 and the storage compartment 20 operate together to provide the user a place to work on items and simultaneous, easy access to the storage compartment 20 that is directly adjacent to the work platform 70. Therefore, a user working on a work piece on the work platform can simultaneously access tools or parts stored in the storage compartment, which are provided side-by-side at the same height.

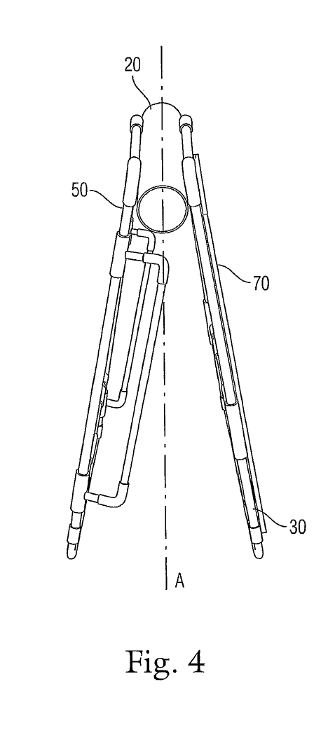

In addition to providing height adjustability, the telescopic retraction of the ground contacting portions 34, 54 also reduces the overall size of the workstation 10, as can be seen by comparison of FIG. 1, which shows the legs in an extended position, and FIG. 4, which shows the legs in a retracted position. The reduced size of the workstation 10 makes the workstation more portable and easier to store.

In one embodiment the upper portions 32, 52 and ground contacting portions 34, 54 are lengths of tubular pipe having a U-shape. The diameter of the tubular pipe of the ground contacting portions 34, 54 is smaller than the diameter of the tubular pipe of the upper portions 32, 52 so that the ground contacting portions 34, 54 can telescopically slide within the upper portions 32, 52. The tubular portions can be made from metal, plastic, or other suitable material and can be bent to form the U-shape. The horizontal portion of the U-shape provides for additional stability and increases the rigidity of the legs. Other shapes and methods of construction can be used and the invention is not limited to such shapes or methods. The legs are not limited to U-shape. Instead of two U-shaped members, each leg can comprise of four straight legs, for instance. Further, the legs are not limited to a tubular pipe, but can have other shapes such as square, rectangular, and other tube shapes. The legs are also not limited to tubes; tracks or other suitable means that allow the length of the legs to be adjusted are among several variations that will be understood by a person in the art.

Referring to FIGS. 1 and 4, the work platform 70 is pivotally connected to upper portion 32 of leg 30 so that the work platform 70 can be moved from an open position to provide a support surface (FIG. 1) to a closed position where the work platform 70 is generally adjacent and parallel to leg 30 (FIG. 4). One end 72 of the work platform 70 is pivotally connected to the upper portion 32 of leg 30 via a hinge joint and the opposite end 74 of platform 70 is free to move from a position adjacent the leg 30 (folded position, FIG. 4) to a position remote from the leg 30 (open position, FIG. 1).

A support member 76, which in one embodiment is generally U-shaped, has one end 77 pivotally connected to the work platform 70 proximate end 74 of the work platform. The second ends 78 of the support member 76 is able to move from a position proximate the work platform (folded position, FIG. 4) to a position to a position remote from the work platform 70 (open position, FIG. 1). A horizontal bar 79 is connected to upper portion 32 of leg 30. The second ends 78 of the support member 76 are detachably coupled to horizontal bar 79 of leg 30. In one embodiment, the ends 78 have a generally C-shaped profile that is supported on the tubular horizontal bar 79 to lock the support member 76 in position. Further, or alternatively, the ends 78 can be detachably connected with horizontal bar 79 or the vertical members of leg 30 via a removable locking pin.

As can be seen in FIG. 1, the support member 76 extends between the work platform 70 and horizontal bar 79 and supports the work platform 70 in an open position. Preferably, the width of support member 76 is less than the distance between the vertical members of leg 30 so that the support member 76 is cable of nesting with leg 30 when in the collapsed position.

As can be appreciated in FIGS. 1 and 4, the legs 30, 50 and central storage compartment 20 form a generally A-frame shape with the central storage compartment 20 at the apex. The central axis that bisects the A-frame is indicated by dashed line A. The work platform 70 is disposed completely on one side of the axis A in both the open and closed positions and is always on the same side of the axis A. Further, when the work platform 70 is in the open position, it is completely disposed to one side of the central storage compartment 20. This is advantageous because it provides unrestricted access to the central storage compartment 20 when the work platform 70 is open and being utilized by a user. A user using the work platform 70 to support a work piece (e.g., section of pipe, piece of wood, etc.) can have ready access to the central storage compartment 20 to obtain tool, parts, etc. contained therein. The work platform 70 and central storage compartment 20 are both supported by legs 30, 50 and, therefore, are located at approximately the same height for convenience of the user.

On the opposite side of the axis A, a storage device 90 is attached to the upper portion 52 of leg 50. Tools, parts, materials can be stored in the storage device 90. The weight of the items stored in the storage device 90 provides a counterbalance to the work platform 70. Because the work platform 70 and the storage device 90 are located on opposite sides of axis A, the weight of items placed on the work platform 70 is counter balanced by the weight of items in the storage device 90. This enhances the stability of the workstation 10.

In one embodiment, the storage device 90 is a box-shape storage bin that has individual storage areas 92. In another embodiment, the storage device 90 can be made from fabric with individual pockets. Items can be placed in the individual pockets for organized storage. The pockets can be made out of fabric or clear plastic material or mesh to provide visibility to the items stored therein. Hook and loop fasteners (e.g., Velcro), snaps, zippers or other closures can be provided to close the pockets and maintain the items therein. The pockets can further be provided with flaps for additional item retention. A storage device 90 formed of fabric provides several advantages, including have a reduced volume then the pockets are empty and increase the ability of the work station 10 to fold and collapse to a compact size.

Referring to FIGS. 1 and 3, the central storage compartment 20 includes an upper lid 22 pivotally connected to a lower portion 24 of the storage compartment 20. The lid 22 can be pivoted open to provide access to an inner storage area 26. Tools, parts, supplies, etc. can be stored in the inner storage area 26. A handle 28 is attached to the storage compartment 20, which allows the user to move and transport the workstation 10.

The legs 30, 50 are pivotally connected to the central storage compartment 20 so that they can be moved from an open position with the legs 30, 50 at an angle to each other and forming a generally A-frame shape with the central storage compartment 20 (see, e.g., FIG. 1) to closed position with the legs 30, 50 generally parallel to each other. A hinged member 40 extends between legs 30 and 50 and is pivotally connected to a leg at its respective ends 42. When the hinged member is in the extended, straight position (see FIG. 1), the hinged member 40 locks the legs in place and prevents them from further pivoting. The hinged member 40 includes an intermediate pivot point 44. Applying force to and moving the intermediate pivot point 42 in an upward direction unlocks the hinge member 40 and allows the legs 30, 50 to fold toward each other. This permits the workstation 10 to be collapsed into a reduced size for portability and storage.

Arrows a-e in FIG. 1 are provided an approximation to illustrate to movement of the various components of the workstation 10 to collapse the workstation from an open configuration (FIG. 1) to a collapsed configuration. Arrow a illustrates the movement of support member 76 towards work platform 70. Arrow b illustrates the movement of work platform 70 towards leg 30. Arrows c illustrate the telescopic retraction of the ground contacting portions 34, 54 into the upper portions 32, 52 and of each respective leg 30, 50. Arrow d illustrates the upward movement of the intermediate pivot point of hinged member 40, which unlocks the hinged member 40 and allows the legs 30, 50 to pivot towards each other. Arrows e illustrate the movement of legs 30, 50 toward each other.

It should be understood that various combinations, alternatives and modifications of the present invention could be devised by those skilled in the art. The present invention is intended to embrace all such alternatives, modifications and variances that fall within the scope of the appended claims.

1. A portable work station, comprising:
first and second legs, each leg having an upper portion and a ground contacting portion telescopically coupled with the upper portion;
a central storage compartment suspended by the legs above the ground, the upper portion of each leg being pivotally connected to a respective side of the central storage compartment so that each leg is movable with respect to the central storage compartment into an open position forming an A-frame with the central storage compartment at the apex of the A-frame.
a work platform pivotally connected to one of the legs and movable entirely on one side of the A-frame from a folded position, wherein a second end of the work platform is proximate the leg to which it is connected, to a working position, wherein the second end is remote from the leg to which it is connected and the first end is adjacent the central storage compartment so that the work platform is disposed on one side of the central storage compartment.

2. The portable work station of claim 1, further including a storage device connected to the other leg and being disposed on the side of the central storage compartment opposite the work platform to provide a counterweight to the work platform.

3. The portable work station of claim 2, wherein the storage device comprises a piece of fabric material and at least one pocket.

4. The portable work station of claim 2, wherein the storage device comprises a bin having at least one compartment.

5. The portable work station of claim 1, wherein the upper and ground contacting portions of each respective leg are telescopically adjustable to adjust an overall length of each leg.

6. The portable work station of claim 1, wherein the first and second legs are movable with respect to the central storage compartment to a closed position such that the first and second legs are generally parallel to each other.

7. The portable work station of claim 1, further including a support member having a first end pivotally connected to the second end of the work platform, wherein the support member is pivotally adjustable between a folded position wherein a second end of the support member is proximate the work platform, to a supporting position wherein a second end of the support member is remote from the work platform and is detachably coupled to the leg to which the work platform connected.

8. The portable work station of claim 7, wherein the support member has a width that is smaller than a width of the leg to which the work platform is connected so that the support member is capable of nesting with the leg to which the work platform is connected when the support member is in the folded position and the work platform is in the collapsed position.

9. The portable work station of claim 1, further including a handle attached to the central storage compartment.
